(19) United States
(12) Patent Application Publication
(10) Pub. No.: US 2015/0069769 A1
(43) Pub. Date: Mar. 12, 2015

(54) LOCK STRUCTURE

(71) Applicant: TAIWAN FU HSING INDUSTRIAL CO., LTD., Kaohsiung City (TW)

(72) Inventor: Chi-Ming Chen, Kaohsiung City (TW)

(73) Assignee: TAIWAN FU HSING INDUSTRIAL CO., LTD., Kaohsiung City (TW)

(21) Appl. No.: 14/182,384

(22) Filed: Feb. 18, 2014

(30) Foreign Application Priority Data
Sep. 6, 2013 (TW) 102216809

(51) Int. Cl. E05B 3/06

(52) U.S. Cl. CPC E05B 3/06
USPC 292/357

(57) ABSTRACT

A lock structure includes a first mounting plate and a positioning ring. The first mounting plate comprises a bottom plate and a plurality of fixing holes. The positioning ring comprises a ring body, an opening and a plurality of positioning members, and each of the positioning members comprises a positioning barrel having a body and a penetration hole. Each of the penetration holes is surrounded by each of the bodies. Each of the penetration holes corresponds to each of the fixing holes to make a fixing member passing through the fixing hole and fixedly secured at a positioning rod via guidance of each of the penetration holes. Therefore, the difficulty of assembly caused by the reason the fixing member is unable to align with the positioning member is eliminated.

### FIELD OF THE INVENTION

The present invention is generally related to a lock structure, which particularly relates to the lock structure with a positioning ring.

### BACKGROUND OF THE INVENTION

A conventional lock structure 200 illustrated in FIG. 7 comprises a first handle assembly 210 and a second handle assembly 220, wherein the first handle assembly 210 comprises an escutcheon 211, a mounting plate 212 and a fixing member 213, and the second handle assembly 220 comprises a supporting rod 221. The mounting plate 212 comprises a fixing hole 212a. The fixing member 213 is fixedly secured at the supporting rod 221 of the second handle assembly 220 via the fixing hole 212a to make the first handle assembly 210 and the second handle assembly 220 engaged with a door 300. The escutcheon 211 covers the mounting plate 212 to shade the fixing member 213. However, the supporting rod 221 of the second handle assembly 220 is located at an assembly hole 310 of the door 300. When one intends to make the fixing member 213 pass through the fixing hole 212a and fixedly secure at the supporting rod 221, the fixing member 213 is not able to align with the supporting rod 221 therefore leading the difficulty in assembling the lock structure 200.

### SUMMARY

The primary object of the present invention is to make a fixing member conveniently and rapidly engaged with a positioning rod via guidance of a positioning barrel of a positioning ring to prevent the fixing member from not aligning with the positioning rod so that the difficulty in assembling lock structure is eliminated. The lock structure of the present invention includes a first mounting plate and a positioning ring. The first mounting plate comprises a bottom plate and a plurality of fixing holes penetrating the bottom plate. The positioning ring comprises a ring body, an opening and a plurality of positioning members. The opening is surrounded by the ring body. Each of the positioning members comprises a positioning barrel, the positioning barrel comprises a body and a penetration hole, and each of the penetration holes is surrounded by each of the bodies. Each of the penetration holes corresponds to each of the fixing holes of the first mounting plate, and each of the fixing holes reveals each of the penetration holes.

In this invention, by each of the penetration holes of the positioning barrel corresponding to each of the fixing holes, when the lock structure is assembled at a door, the fixing member is able to align with a positioning rod via guidance of each of the penetration holes so as to make the assembly of the lock structure more convenient and more rapid.

### DESCRIPTION OF THE DRAWINGS

FIG. 1 is a perspective assembly diagram illustrating a lock structure in accordance with a first embodiment of the present invention.

FIG. 2 is a perspective exploded diagram illustrating the lock structure in accordance with the first embodiment of the present invention.

FIG. 3 is a partial section view illustrating the lock structure in accordance with the first embodiment of the present invention.

FIG. 4 is a section view illustrating the lock structure in accordance with the first embodiment of the present invention.

FIG. 5 is a perspective assembly diagram illustrating a lock structure in accordance with a second embodiment of the present invention.

FIG. 6 is a section view illustrating the lock structure in accordance with the second embodiment of the present invention.

FIG. 7 is a section view illustrating a conventional lock structure.

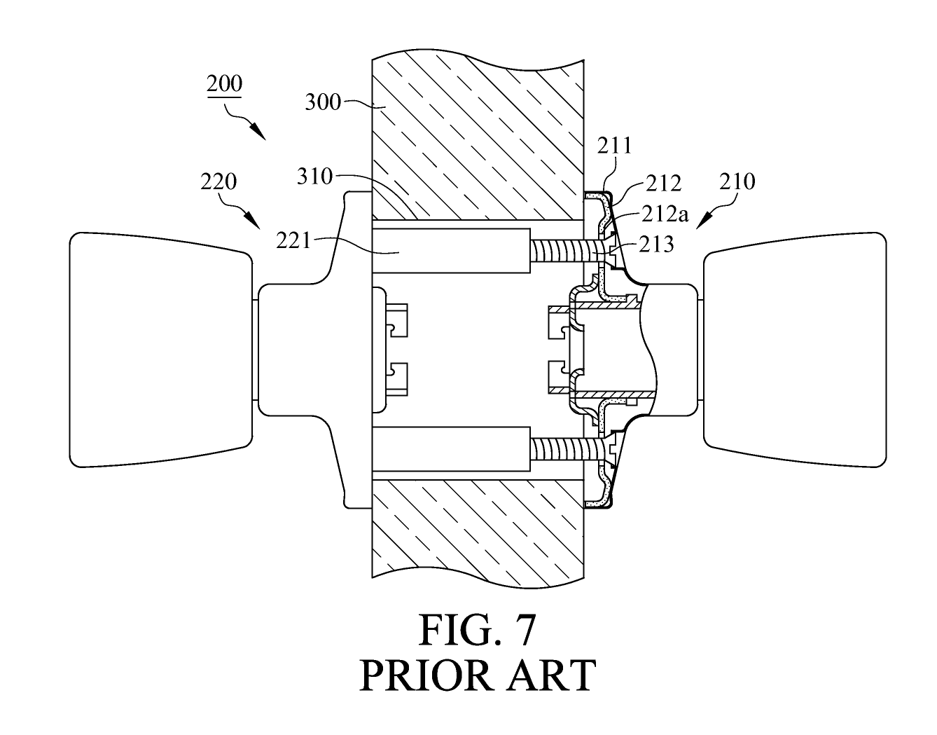

### DETAILED DESCRIPTION OF THE INVENTION

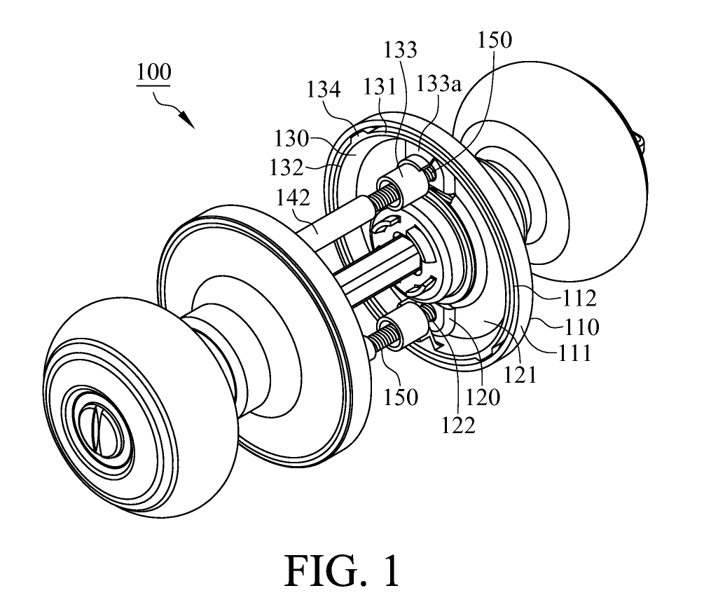

With reference to FIGS. 1, 2, 3 and 4, a lock structure 100 in accordance with a first embodiment of the present invention includes an escutcheon 110, a first mounting plate 120, a positioning ring 130, a second mounting plate 140 and a plurality of fixing members 150, wherein the first mounting plate 120 and the second mounting plate 140 are located at an inside and an outside of a door D respectively. The lock structure 100 is engaged with the door D by the fixing members 150.

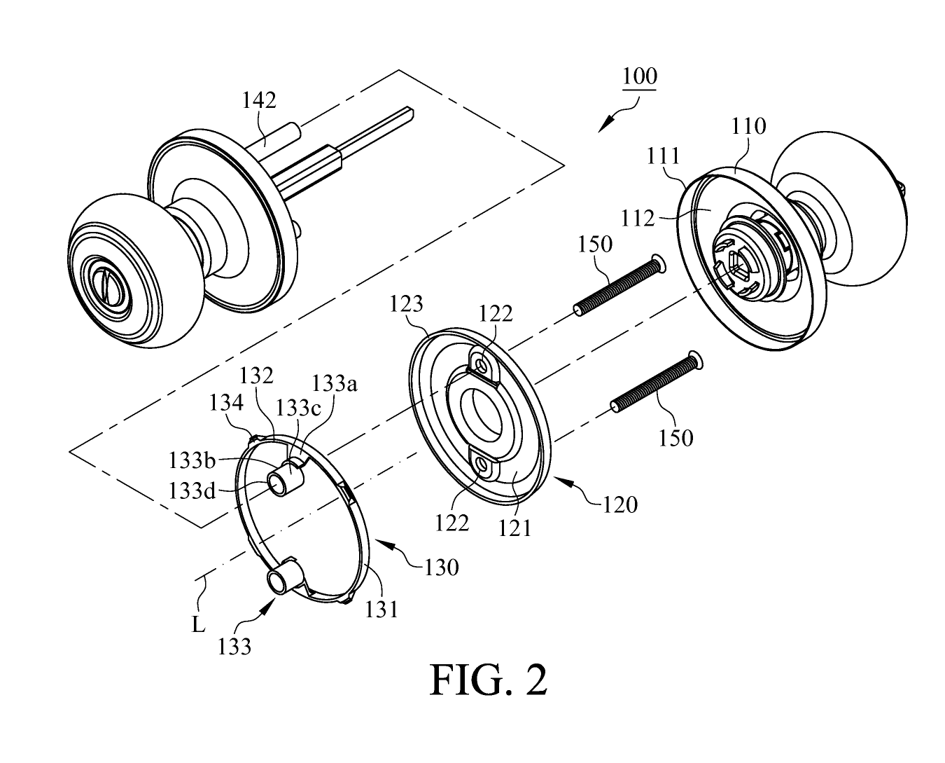

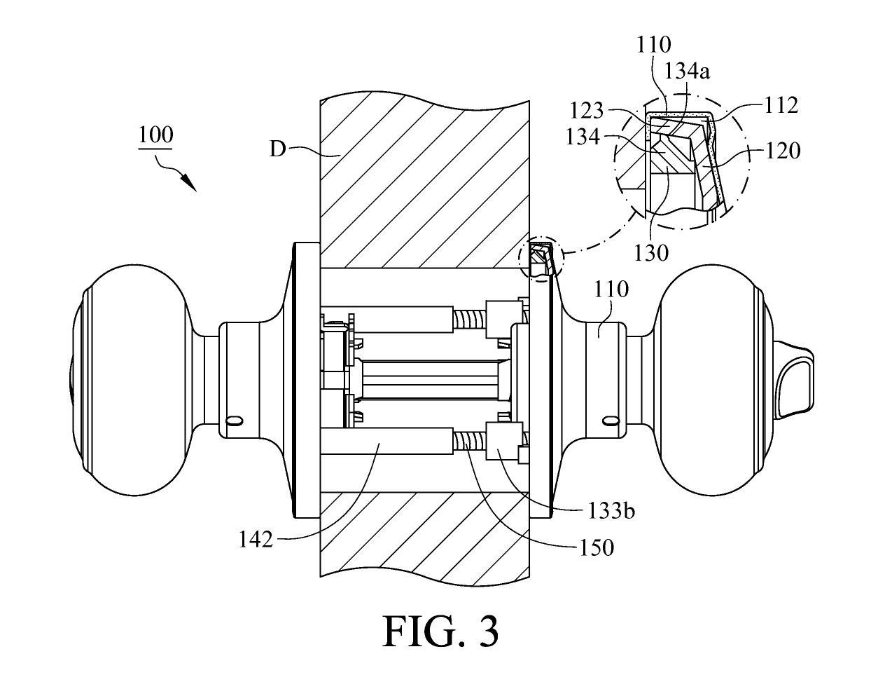

Please refer to FIGS. 2, 3 and 4, the escutcheon 110 comprises a ring wall 111 and an accommodating slot 112 surrounded by the ring wall 111, wherein the first mounting plate 120 is disposed within the accommodating slot 112, and the escutcheon 110 covers the first mounting plate 120. The first mounting plate 120 comprises a bottom plate 121, a plurality of fixing holes 122 and a lateral wall 123 formed at the bottom plate 121. Each of the fixing holes 122 penetrates through the bottom plate 121. With reference to FIG. 3, in this embodiment, a distal end of the ring wall 111 of the escutcheon 110 is bent toward the accommodating slot 112 to make the first mounting plate 120 constrained within the accommodating slot 112 in a wrapping manner.

With reference to FIGS. 2, 3 and 4, the positioning ring 130 is disposed within the accommodating slot 112, and the first mounting plate 120 is located between the escutcheon 110 and the positioning ring 130. The positioning ring 130 comprises a ring body 131, an opening 132 and a plurality of positioning members 133, wherein the opening 132 is surrounded by the ring body 131. Each of the positioning members 133 comprises a connection rib 133a and a positioning barrel 133b, each of the connection ribs 133a connects to the ring body 131, and the connection rib 133a is extended toward a center line L of the ring body 131. The positioning barrel 133b comprises a body 133c and a penetration hole 133d, each of the bodies 133c connects to each of the connection ribs 133a and extends toward the second mounting plate 140. Each of the penetration holes 133d is surrounded by each of the bodies 133c. Each of the penetration holes 133d corresponds to each of the fixing holes 122 of the first mounting plate 120, and each of the fixing holes 122 reveals each of the penetration holes 133d. In this embodiment, the positioning ring 130 comprises a plurality of protrusions 134 formed at the ring body 131, wherein each of the protrusions 134 is located between the lateral wall 123 and the ring body 131, and a distal end of each of the protrusions 134 comprises a guiding surface 134a. The guiding surface 134a faces toward the first mounting plate 120, and the guiding surface 134a is a curved surface. When the positioning ring 130 assembles the first mounting plate 120, the guiding surface 134a of each of the protrusions 134 contacts against the lateral wall 123 of the first mounting plate 120, and the ring body 131 retracts toward the center line L inwardly owing to flexibility of the ring body 131. Thereafter, by elasticity of the ring body 131, the positioning ring 130 is lodged inside the first mounting plate 120 via the protrusions 134.

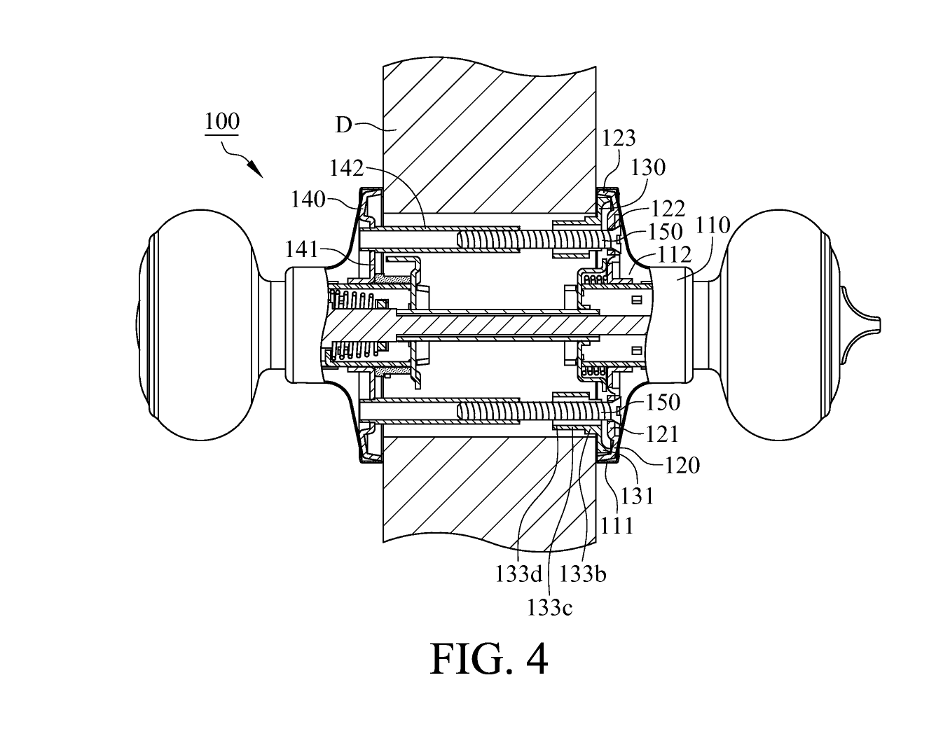

With reference to FIG. 4, the second mounting plate 140 comprises a surface 141 and a plurality of positioning rods 142, wherein the surface 141 faces toward the first mounting plate 120, each of the positioning rods 142 engages with the surface 141 and protrudes from the surface 141, and each of the positioning barrels 133b of the positioning ring 130 corresponds to each of the positioning rods 142. Therefore, once the penetration hole 133d of each of the positioning barrels 133b is aligned with each of the positioning rods 142, each of the fixing members 150 enables to pass through each of the fixing holes 122 of the first mounting plate 120 and to fixedly secure at each of the positioning rods 142 of the second mounting plate 140 via guidance of each of the penetration holes 133d so as to make the lock structure 100 engaged with the door D. In this invention, the assembly of the lock structure 100 is more convenient and more rapid.

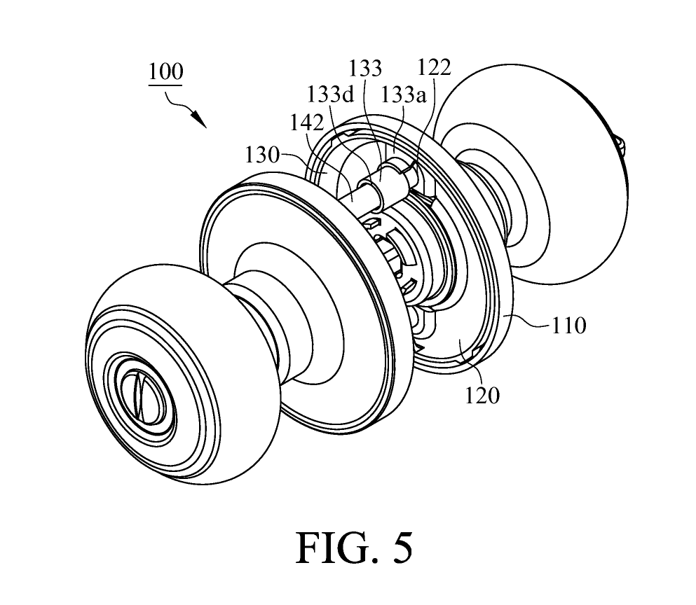

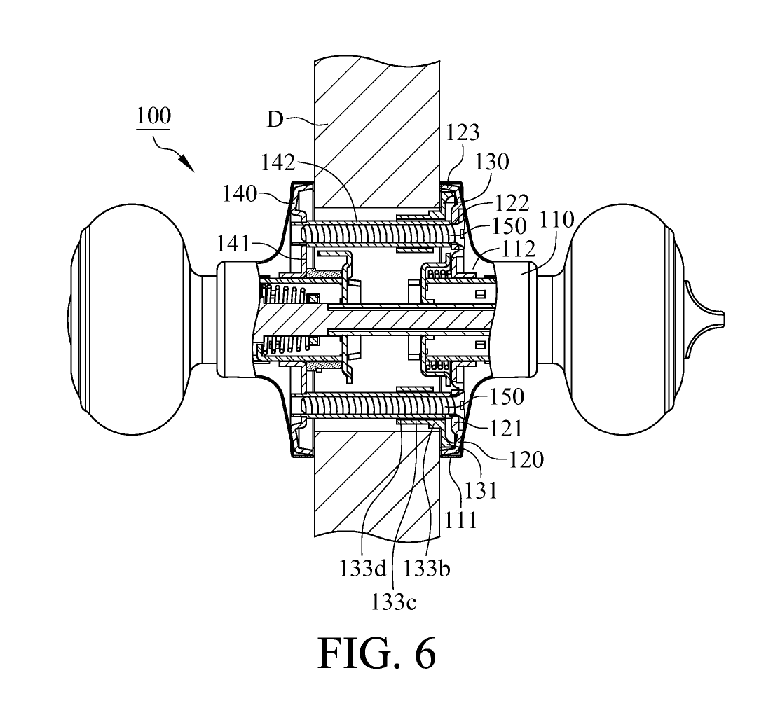

With reference to FIGS. 5 and 6, a lock structure 100 is illustrated in accordance with a second embodiment of the present invention. The primary difference between the second embodiment and the first embodiment is that each of the positioning rods 142 of the second mounting plate 140 is inserted into each of the penetration holes 133d of the positioning member 133 to make each of the positioning rods 142 alignable with each of the fixing holes 122 of the first mounting plate 120. Accordingly, when each of the fixing members 150 passes through each of the fixing holes 122 of the first mounting plate 120, each of the fixing members 150 is able to fixedly secure at each of the positioning rods 142 so as to ignore the step of making the penetration hole 133d of each of the positioning barrels 133b align with each of the positioning rods 142 for making the assembly of the lock structure 100 more rapid.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A lock structure includes:
a first mounting plate having a bottom plate and a plurality of fixing holes penetrating the bottom plate; and
a positioning ring having a ring body, an opening and a plurality of positioning members, the opening is surrounded by the ring body, each of the positioning members comprises a positioning barrel having a body and a penetration hole surrounded by the body, each of the penetration holes corresponds to each of the fixing holes of the first mounting plate, each of the penetration holes is revealed by each of the fixing holes.

2. The lock structure in accordance with claim 1, wherein each of the positioning members comprises a connection rib, one end of each of the connection ribs connects to the ring body, and the other end of each of the connection ribs connects to each of the bodies.

3. The lock structure in accordance with claim 2, wherein the connection rib extends toward a center line of the ring body.

4. The lock structure in accordance with claim 1, wherein the first mounting plate comprises a lateral wall formed on the bottom plate, the positioning ring comprises a plurality of protrusions formed at the ring body, each of the protrusions contacts against the lateral wall of the first mounting plate, and each of the protrusions is located between the lateral wall and the ring body.

5. The lock structure in accordance with claim 4, wherein each of the protrusions comprises a guiding surface facing toward the first mounting plate, and the guiding surface is a curved surface.

6. The lock structure in accordance with claim 1 further includes a second mounting plate and a plurality of fixing members, wherein each of the fixing members passes through each of the fixing holes of the first mounting plate and the penetration hole of each of the positioning barrels to engage with the second escutcheon.

7. The lock structure in accordance with claim 1 further includes a second escutcheon having a surface and a plurality of positioning rods, the surface faces toward the first mounting plate, each of the positioning rods engages with the surface and protrudes from the surface, each of the positioning rods is inserted into each of the penetration holes of the positioning member to make each of the positioning rods align with each of the fixing holes of the first mounting plate.

8. The lock structure in accordance with claim 7 further includes a plurality of fixing members, and each of the fixing members passes through each of the fixing holes and engages with each of the positioning rods.

9. The lock structure in accordance with claim 1 further includes an escutcheon covering the first mounting plate, wherein the first mounting plate is located between the escutcheon and the positioning ring.

10. A positioning ring of lock structure includes:
a ring body, wherein an opening is surrounded by the ring body; and
a plurality of positioning members, each of the positioning members comprises a positioning barrel, each of the positioning barrels comprises a body and a penetration hole, each of the penetration holes is surrounded by each of the bodies.

11. The positioning ring of lock structure in accordance with claim 10, wherein each of the positioning members comprises a connection rib, one end of each of the connection ribs connects to the ring body, and the other end of each of the connection ribs connects to each of the bodies.

12. The positioning ring of lock structure in accordance with claim 11, wherein the connection rib extends toward a center line of the ring body.

13. The positioning ring of lock structure in accordance with claim 10 further includes a plurality of protrusions formed at the ring body.

14. The positioning ring of lock structure in accordance with claim 13, wherein each of the protrusions comprises a guiding surface, and the guiding surface is a curved surface.
